(19) United States
(12) Patent Application Publication
(10) Pub. No.: US 2019/0053518 A1
(43) Pub. Date: Feb. 21, 2019

(54) METHOD FOR MECHANICALLY KNOTTING PET CHEWS AND PET CHEWS MADE THEREBY

(71) Applicant: Peter Brett Wheeler, Honolulu, HI (US)

(72) Inventor: Peter Brett Wheeler, Honolulu, HI (US)

(21) Appl. No.: 15/682,543

(22) Filed: Aug. 21, 2017

(51) Int. Cl. A23K 40/25; A23K 20/10

(52) U.S. Cl. CPC A23K 40/25; A23K 20/10

(57) ABSTRACT

A fully mechanized method for making artificial knotted pet chews such as edible dog bones. The method employs a knot box having a tubular chamber in the form of a knot. Rolled or folded pet chew material is mechanically inserted into and pushed through the chamber of the knot box, clamped at the far end, pulled from both ends to form a knot, and then withdrawn. According to one embodiment, the knot box separates to facilitate knotting and withdrawal of the knotted chew. The process is repeated for double knotted chew. The method can be used with pet chews made from treated rawhide, extruded plant material, and rawhide or extruded plant material combined with a meat layer. The method allows the manufacture of knotted dog bones without the use of human labor, avoiding the consequent costs and other drawbacks encountered when requiring workers to engage in simple, repetitive manual tasks.

### CROSS-REFERENCE TO RELATED APPLICATIONS

This application does not claim benefits of any earlier filed application.

### STATEMENT REGARDING FEDERALLY SPONSORED RESEARCH OR DEVELOPMENT

This invention was not supported in whole or in part by government funds.

### FIELD OF THE INVENTION

The invention relates to edible pet chews. More particularly, the invention describes a method for mechanically knotting artificial pet chews such as edible dog bones, and the pet chews made using the method.

### BACKGROUND OF THE INVENTION

The Rawhide Dog Chew. Rawhide based dog chews have been manufactured and marketed commercially for over 50 years. Rawhide dogs chews are manufactured by taking the second or lower layer of a cow hide (skin). The hide of a cow grows to different depths all over the cows body, consequently when removed the hide is of variable thickness. So the hide is processed through a splitting machine that takes off a constant gauge upper layer of hide which is usually chemically tanned for use as leather.

The lower layer that remains with variable thickness is not suitable for leather use and has lower value. For use in animal chews, this layer of hide is then cleaned using bleaching agents and rinsed with water. While wet, the rawhide is soft and malleable and can be manipulated by hand, rolled, shaped, and knotted into artificial dog bones. After drying the rawhide becomes very stiff and provides appropriate resistance with some flavor to the chewing of a dog. It softens with the dog's saliva so that is can be chewed into pieces and ultimately digested, being comprised of 80% protein.

The YouTube video accessible at https://www.youtube.com/watch?v=nIAarnbs8do on Jul. 20, 2017, shows how the rawhide discard layer is cut into rectangles and softened to make it malleable so that it can be rolled and knotted by hand for use in dog chews.

The Dingo Bone. A new innovation on the rawhide dog chew, Sherrill (U.S. Pat. No. 5,673,653), was introduced in the late 1990's. The '653 patent, produced commercially as the Dingo Bone and depicted in FIG. 1, recites the addition of an inner layer of enticing meat in order to provide extra motivation for dogs who might not otherwise find the effort of chewing rawhide sufficiently rewarding. The meat sheet/layer is superimposed over the rawhide sheet/layer and the two sheets/layers are rolled together so that the meat is enclosed within the rawhide layer. The rolled composite is then knotted manually to form the classic knotted bone shape.

No machine exists capable of the manual dexterity of the knotting actions required in the final steps of producing knotted rawhide dog chews and, in particular, that might be capable of accommodating the variation in the gauge thickness of both the meat and rawhide sheets. Most of the manufacturing is carried out in low cost labor countries ($5/day), such as China and South East Asia. As such, the marginal cost of completing the knotting procedure using human labor results in an acceptable retail price in the consumer markets.

The Smart Bone. In 2010, Stern (U.S. Pat. No. 7,677,203) patented an innovation in animal chews comprising replacing the outer rawhide sheet of the layered knotted dog bone with an extruded, substantially plant based sheet made of materials such as corn, rice, potato starch, wheat gluten, among others. Like the Dingo Bone, The Stern “Smart Bone” includes an edible preferably meat based inner sheet. When initially extruded, the plant based sheets are malleable and can be manipulated. After drying they harden and provide resistance to chewing. The Smart Bone offers the advantage over the Dingo Bone that flavor and smell can easily be added to the extruded plant based ingredients so the palatability of the inner layer became less important. The dwell or chewing time is comparatively lower than that of the rawhide chew but the overall utility is greater. As with the Dingo Bone, two sheets are superimposed and rolled together and both ends knotted manually. The Smart Bone innovation was timely because the cost of rawhide has increased historically each year with improvements to the tanning process and other higher uses for rawhide such as gelatin and cosmetics, thus increasing the economic attractiveness of using plant based material as an alternative material for pet chews in place of the lower hide layer.

The method of Stern is illustrated in FIG. 2, depicting plant based starch sheets being extruded into continuous sheets (shown) or tubes using a commercially available extrusion machine. Once extruded, the sheets or tubes are cut into rectangles or segments for combination with the meat sheet, rolled and hand knotted into the bone shape as illustrated in FIG. 3. This method is also illustrated in the YouTube video accessible at https://youtu.be/SjHwCsF2gk0 on Jul. 20, 2017, demonstrating the hand tying of a cornstarch and meat dog chew.

Current Environment. The cost of labor is increasing in most Asian countries. Labor is moving up-market and where workers were plentiful for doing this type of work, requiring strenuous and repetitious manual dexterity, it is becoming difficult to recruit them.

Adding to this are problems with perceived quality of food products emanating from Asia, specifically China, with the embarrassing 2007 wheat gluten based dog food recall where manufacturers were artificially boosting protein levels using an banned adulterant called melamine. As a result of this and related events, there has been an increasing distrust of Asian based manufacturing quality assurance.

Whereas previously, manufacturing of artificial dog bones took place in Asia because the cost to manufacture these goods in the United States would be five times as much, currently it may not even been possible to find U.S. domestic labor willing to engage in such manufacturing activities.

Accordingly, there is a need for a method for the fabrication of artificial dog bones in which the step of knotting the dog bone layers in mechanized in order to avoid the extensive use and increasing expense of human labor.

While dog chews come in all shapes, rolls/sticks/chips/braids, ninety percent of all dog chews are sold in a double knot form. Tying a rawhide or rawhide and meat knotted bone mechanically using the materials described above is no easier now than it was when such artificial done bones first become commercially available 20 years ago. Even with advancements in robotics, tying an overhand knot is difficult but tying the second knot is even more difficult, particularly using a rolled sheet of wet rawhide.

The innovation in the '203 patent, in which extruded plant material is used in lieu of treated rawhide scraps, creates a new opportunity because extruding a constant gauge sheet or tube shape is more susceptible to a mechanized knotting process.

Current robotic options for tying overhand knots do not provide a cost effective solution to the problem of rising labor costs. Assuming the current cost of approximately $30,000 per robot arm, and that a minimum of two arms would be required for a knotting procedure, the payback over human labor would require many years. Moreover, robotics is not expected to be significantly faster than human labor tying knots. Accordingly, robotics in its current state does not offer an attractive solution to the increasing costs of the human labor factor in the fabrication process of artificial dog bones.

Illustrating this is a YouTube video showing robotic arms learning to tie knots accessible at https://www.youtube.com/watch?vAJllD3AiSqs on Jun. 20, 2017. The process is time and labor intensive, requiring many individual steps. The robotic arms make use of the flat surface. Whether robots are spatially aware enough to perform this function “in the air”, or whether the task can be successfully completed on a flat surface, are questions that remain unanswered.

An object of the current invention is to provide a method for fabricating artificial dog bones in which the tying step is mechanized so as to avoid the use of human labor.

Another object of the current invention is to provide a method for fabricating artificial dog bones in which the bones are double knotted without the use of human labor.

An further object of the current invention is to provide a method for fabricating artificial dog bones in which the tying step is mechanized without or while minimizing the complexity and cost of using robotics.

A further object of the current invention is to provide a fully mechanized method of making knotted pet chews to include chews fabricated from rawhide, chews fabricated from extruded plant material, and chews that include a meat layer.

A further object of the current invention is to reduce the cost to produce knotted animal chews in countries with higher labor costs.

A further object of the current invention is to encourage the U.S. domestic production of knotted dog chews.

### SUMMARY OF THE INVENTION

These and other objects are accomplished in the present invention, an improved method for making knotted animal chews wherein the step of knotting and double knotting is mechanized, and knotted animal chews produced using the novel method.

According to a preferred embodiment of the present invention, sheets of extruded plant material are optionally rolled together with a meat layer and then mechanically knotted with the aid of a specially configured knot box.

According to a further preferred embodiment of the present invention, sheets of extruded plant material are optionally rolled together with a meat layer and then mechanically knotted, and then knotted again, each time with the aid of a specially configured knot box.

According to a further preferred embodiment of the present invention, treated rawhide scraps are optionally rolled together with a meat layer and then mechanically knotted, and then knotted again, each time with the aid of a specially configured knot box.

The specially configured knot box is comprised of a housing with tubular chamber, said chamber taking the form of an overhand knot with the inner surface of the chamber cutaway, an entry port and an exit port, with the proximal entry port region widened to accommodate the knot formed in the rolled chew material.

The method of the invention comprises taking rolled or folded layered animal chew material, pushing a first end of the rolled material into the entry port of the knot box chamber until that end extends out the exit port of the chamber, grasping and pulling on both ends of the rolled material so that a knot forms along the length of the material inside the knot box chamber, and then withdrawing the knotted material from the entry port. The material is then rotated and the process is repeated on the second end of said folded chew material in order to form a double knot.

According to a second embodiment of the specially configured knot box, the box is similarly constructed with a tubular chamber in the form of a overhand knot, but is comprised of two mirror image halves split along the chamber axis. According to the method of this embodiment, the box is separated into two pieces after the rolled material is threaded through, and before the ends of the material are pulled to form a knot. The knot box used in this embodiment does not require the inside surface of the tubular chamber to be cutaway or the entry port region to be widened.

The process is mechanized by having a mechanical arm grab, push and pull the rolled chew material through the entry port and within the knot box, and having a mechanical clamp grasp the inserted end of the material once extended beyond the exit port.

The process can be used to knot a variety of animal chew materials and animal chew materials configured with different layers, configurations, dimensions and cross-sections.

One aspect of the subject invention is to mechanize the tying step of fabricating knotted animal chews.

A further aspect of the subject invention is to mechanize the entire process of making artificial knotted dog bones, thereby avoiding human labor and the costs associated therewith.

A further aspects of the subject invention is to modify the current method of fabricating artificial knotted dog bones to lower the cost of manufacture in countries with high labor costs, thereby encouraging, for example, the U.S. domestic manufacture of such products.

Still a further aspect of the current invention is to provide a method for fabricating artificial dog bones in which the tying step is mechanized without or while minimizing the complexity and cost of using robotics.

### BRIEF DESCRIPTION OF THE DRAWINGS

FIG. 1 shows a dog chew employing the technology disclosed in the Sherrill patent with a rawhide and meat layer, rolled and knotted into the shape of a bone, available under the Dingo brand.

FIG. 2 shows extrusion machinery currently used in manufacturing process of pet chews made from plant or other malleable material.

FIG. 3 shows the prior art method of hand knotting the extruded plant material to form edible pet chews.

FIG. 4 is a schematic drawing in cutaway format of a knot box for use in the mechanical facilitation of overhand knotting of the present invention.

FIG. 5 is a schematic drawing showing the intersection of the elongated member within the chamber of the knot box used in the method of the subject invention.

FIG. 6. shows a knot made using the mechanized knotting process of the subject invention.

FIGS. 7A through 7C illustrate the method of the present invention using a first embodiment knot box that does not separate but that includes an enlarged portion of the knot chamber to accommodate knotting.

FIGS. 8A through 8D illustrate the method of the present invention using a second embodiment knot box that separates into two halve for the knotting step of the invention.

FIGS. 9A and 9B illustrate alternative folded and layered structures for the extruded plant or other flexible material used in the method of the subject invention.

FIGS. 10A and 10B illustrate the steps of the methods of the invention according to two embodiments of the invention.

### DETAILED DESCRIPTION OF THE PREFERRED EMBODIMENTS

The subject invention, a mechanized method for making knotted animal chews, exploits the difference between pushing and pulling an elongated flexible member within a knot box. When pushed, the elongated member having sufficient stiffness in a curved tube will tend to follow the outside edge of the tube. When pulled, the member will tends to converge to the shortest path between the points at which the tension is being applied, subject to any obstacles in the way.

The method of the subject invention lends itself to a non-robot mechanized approach, or alternatively a single robotic arm mechanized approach. The method adopts technology described by M. Bell and D. Balkcon, “Knot Tying with Single Fixtures”, Robotics and Automation, 2008. ICRA 2008. IEEE May, 2008. The Bell and Balkcon study focused on tying small gauge wire thread using a knot box. The subject invention adopts that method to rolled sheets of edible pet chew material, whether treated rawhide or extruded plant material or both combined, in the form of larger gauge flexible tubing.

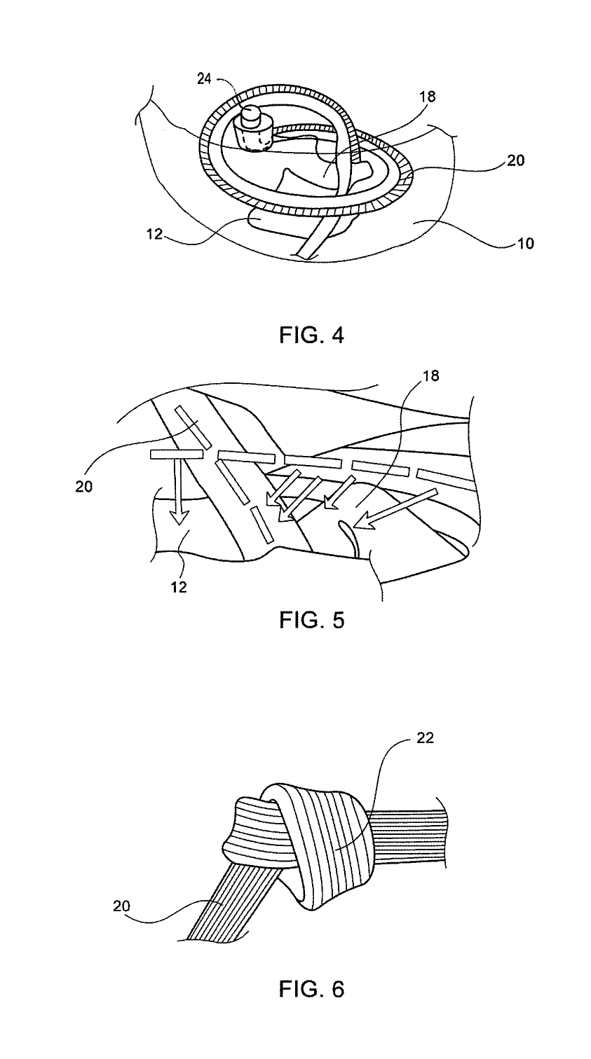

The method of the subject invention employs a knot box housing configured with an inside tubular chamber having an entry port, an exit port, and shaped for the desired knot. For purposes of a preferred embodiment of the instant invention, the tubular chamber within the knot box is configured for a standard overhand knot. The tubular chamber is expanded to avoid self-intersection. Illustrated in FIG. 4 is schematic cutaway drawing of a knot box for making overhand knots.

According to the method of the subject invention, layered animal chew material is rolled and folded to form a flexible elongated member. The elongated member is pushed into the entry port of a knot box tube to form an loose overhand knot. However the knot cannot be removed without dissolving or breaking the knot box. Although the knot so formed could be extracted by cutting the box and separating the pieces, this would require that the knot box be separated and then re-assembled for each use.

A second design step is needed for providing a solid piece knot box that does not require separation and reassembly for each use. Because a flexible elongated member will move to the inside edge of a curved tube when it is pulled, the knot box is further configured to remove or cutaway a portion of the inside surface of the tubular chamber of the box allowing the knot, once formed, to be tightened around itself without obstacle, as illustrated in FIG. 5. The chamber is also widened in the area of the entry port to allow the knotted member to be withdrawn without binding. Once the knot is tightened the knot volume is reduced, and as long as the entry port and proximal portion of the chamber is sufficiently wide, the knot can be tightened and withdrawn via the opening.

With the knot box properly configured, a mechanical arm is employed that automatically takes a precut length of the extruded sheet that has been rolled/folded into a solid or hollow tube elongated member. Holding the elongated member at a point along its length, the arm inserts a first end of the member into the entry port of an overhand knot configured knot box and pushes said member through the tubular chamber of the knot box until the inserted end extends out the exit port of the knot box. The stiff member will follow the outside surface of the tubular knot box chamber to form a loose overhand knot. Pushed sufficiently, the first end of the elongated member presents itself at the exit port of the knot box tube. This end is then automatically clamped by a clamping mechanism. The mechanical arm holding the member along its length then reverses the pushing action to a pulling action, tightening the loose knot that is formed along the length of the elongated member. The cutaway along the inside surface of the tubular chamber allows the knot to form without obstruction. After tightening, the clamp on the exit port end of the box releases the first end of the elongated member, and the mechanical arm withdraws the now knotted member from the box through the widened entry port. Illustrated in FIG. 6 is rolled animal chew material knotted mechanically in accordance with the method described above.

For a double knotted configuration, the mechanical arm rotates 180 degrees and inserts the un-knotted or second end of the now single knotted elongated member into the knot box and the process is repeated resulting in an artificial dog bone demonstrating two knots.

An alternative preferred embodiment of the method of the subject invention employs a knot box that separates into two sides or pieces. According to this embodiment, the tubular chamber within the knot box does not include a cutaway along its inside surface, because once the knot box is separated, there are no obstructions to knotting. In all other respects, the essential configuration of knot box, the pathway for the inter-looping of the knot, and the hollow center chamber of the box remain the same as in the first disclosed embodiment.

The method of this alternative embodiment comprises the steps of feeding a first end of a rolled or folded edible chew material (the “elongated member”) into the knot box until the first end presents itself at the exit port, clamping said first end, separating the two sides of the knot box, pulling on the each end of the elongated member simultaneously to form a knot along the length of the elongated member, releasing the first end of the member from the clamp, re-assembling the two-piece knot box, rotating the now knotted member 180 degrees, inserting the second end of the single knotted member into the entry port of the re-assembled knot box, and repeating the steps to form a double knotted animal chew. A mechanical arm can be used to hold, separate and reassemble the two halves of the alternative embodiment knot box.

Illustrated in FIG. 4 in cutaway format is a first embodiment knot box 10 with an elongated member 20 sitting within a tubular chamber 12 formed within the central region of knot box 10. According to this embodiment, chamber 12 takes the form of an overhand knot.

Chamber 12 exhibits an enlarged inside section 18 such that, when member 20 is pulled from either side and knotted, the overlapping aspect of member 20 is clear of any obstruction that could hinder or obstruct the knotting process.

The details of the chamber 12 and cutaway surface 18 relative to elongated member 20 are illustrated in FIG. 5. FIG. 5 shows the juncture where sections of elongated member 20 cross and knot. Chamber surface 18 has been cutaway or enlarged to allow the knot formed in member 20 to tighten upon itself without portions of box 10 obstructing the knot.

Depicted in FIG. 6 is elongated member 20 exhibiting a knot 22 following the mechanized knotting process of the subject invention.

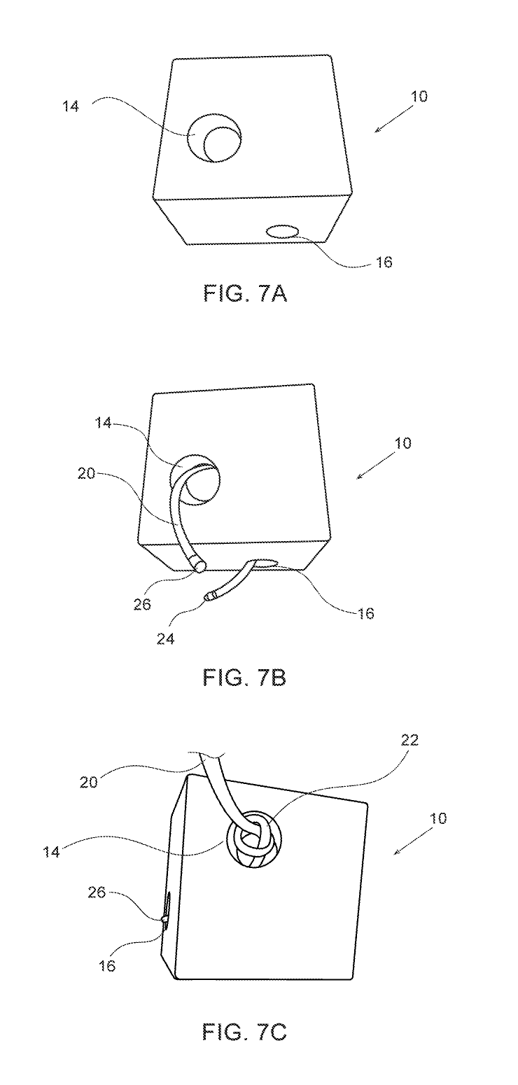

A first embodiment knot box 10 is illustrated in FIG. 7A through 7C. Referring first to FIG. 7A, knot box 10 has an entry port 14 and an exit port 16. Entry port 14 is large relative to exit port 16 to accommodate the withdrawal of member 20 from box 10 once member 20 is knotted.

A first end 24 of elongated member 20 is threaded into entry port 14 until first end 24 presents itself from and extends out beyond exit port 16 as shown in FIG. 7B, with the second end 26 of elongated member 20 extending out from entry port 14. The first end 24 and second end 26 of member 20 are then pulled simultaneously, forming a knot within box 10 along member 20's length. The member 20 with knot 22 can then be withdrawn from box 10 through enlarged entry port 14 as shown in FIG. 7C.

Although entry port 14 is illustrated in FIGS. 7A through 7C as larger than exit port 16, the ports can also be the same size so long as entry port 14 is sufficiently large to accommodate knot 22.

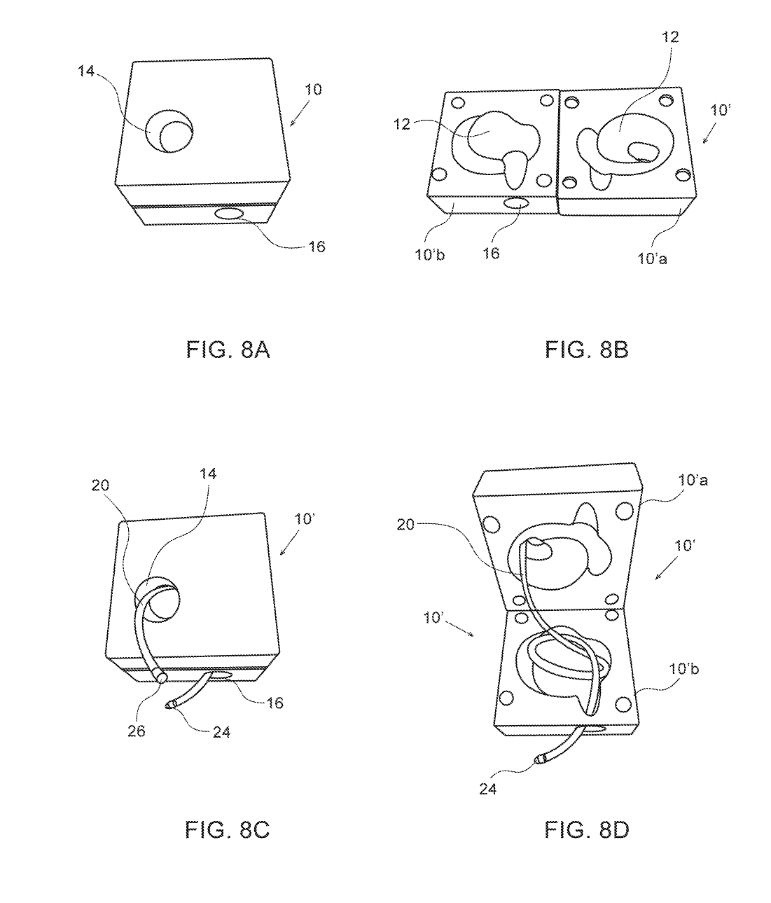

A second embodiment knot box 10′ is illustrated in FIG. 8A through 8D. Referring first to FIG. 8A, knot box 10′ has an entry port 14 and an exit port 16 as did first embodiment knot box 10.

According to this second embodiment as best illustrated in FIG. 8B, box 10′ is separable into box halve 10′a and box half 10′b, sliced along the longitudinal axis of tubular chamber 12, exposing chamber 12. According to this embodiment, chamber 10 does not need to include cutaway region 18 shown in FIGS. 4 and 5 because the knotting takes place after box 10′ is separated into halves.

Box halves 10′a and 10′b can be identical mirror image halves, or one of the halves can be more substantial than the other, so long as when split, tubular chamber 12 is sufficiently exposed to allow withdrawal of overlapping member 20 before knotting.

According to the method of the subject invention using second embodiment knot box 10′, a first end 24 of elongated member 20 is threaded into entry port 14 until first end 24 presents itself from and extends out beyond exit port 16 as shown in FIG. 8C, with the second end 26 of elongated member 20 extending out from entry port 14.

Thereafter, first half 10′a and second half 10′b of knot box 10′ are separated as shown in FIG. 8D releasing member 20 from the confines of chamber 12. First end 24 and a second end 26 of member 20 are then pulled simultaneously, forming knot 22 along member 20's length. Box 10′ can then be reassembled and second end 26 of knotted member 20 can be inserted into box 10′ with the steps repeated to form a double knotted pet chew. According to second embodiment 10′, entry port 14 is still large relative to exhibit port 16 to accommodate a first knot during the double knotting process

Although knot boxes 10 and 10′ are shown in FIGS. 7A through 7C and 8A through 8D as boxed shaped, knot boxes 10 and 10′ can also be rectangular or irregular, the term “box” being used herein loosely and including housing of any shape or form capable of enclosing chamber 12.

According to a further embodiment, not shown, the method would employ four sizes of knot boxes to accommodate layered and rolled rawhide or extruded plant material of different diameters to produce the four usual sizes—mini, small, medium, and large—of commercially marketed artificial dog bones.

Plant material can be prepared and extruded to exhibit appropriate flexibility and stillness suitable for mechanical tying using the disclosed knot box method. When using treated rawhide remnants, attention must be paid to the moisture content of the hydrated rawhide sheet. Hand tied rawhide is typically in a very soft state for ease of tying and would not be sufficiently stiff to be pressed along the outside surface of the knot box chamber. With control of the rawhide moisture content, appropriate stiffness is obtainable preserving treated rawhide scrap's utility for use in the mechanized method of the subject invention.

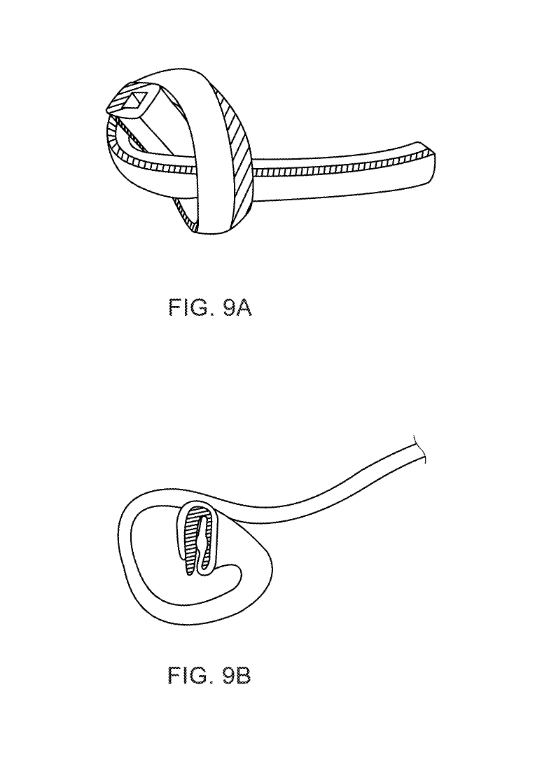

Also encompassed within the subject invention are methods of rolling and folding extruded edible chew materials to produce elongated structures suitable for use in the mechanized knotting protocol described herein. Alternative structures are illustrated in FIGS. 9A and 9B.

Illustrated in FIG. 9A is an extruded hollow square tube that employ a dual extrusion method extruding two layers, a rawhide or extruded plant material layer, typically fabricated as a “white layer,” and a meat or protein component typically fabricated as a “red layer.”

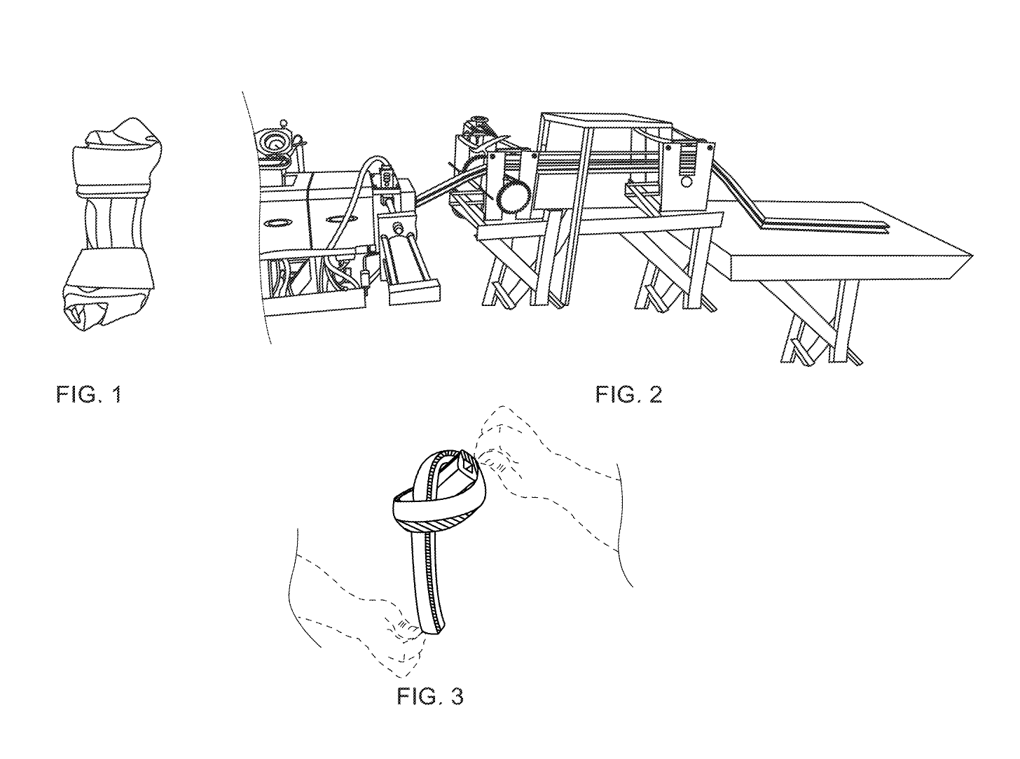

Illustrated in FIG. 9B is a single flat sheet of edible animal chew material extruded though a flat die aperture. According to this method, a single flat sheet using a machine like the one depicted in FIG. 2 is threaded through a secondary folding die/roller that folds the sheet over. Thirdly, the folded sheet is brought together by, for example, a dual extrusion where a second extruder forms a first “white” layer. The folded first white layer and a second meat or protein “red” layer are introduced together in a third die/roller where the red piece is layered together and the white piece and folded over the top of the red piece.

Many other variations and profiles of rolled and folded dual and even tri-layered chew material can be employed in the method of the present invention without departing from its intent and scope.

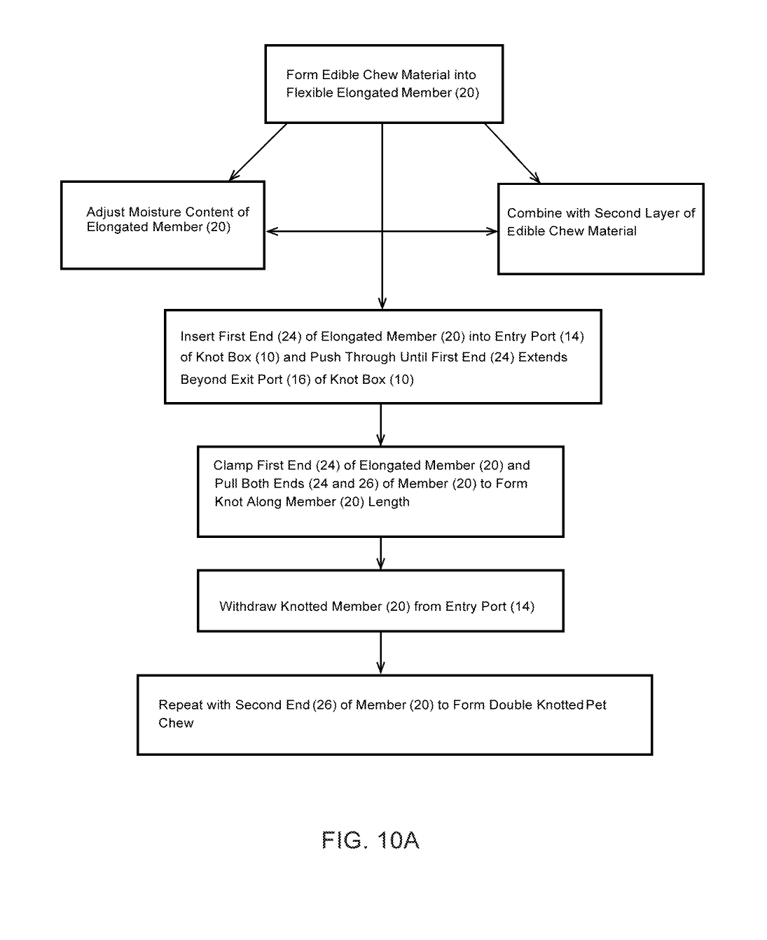

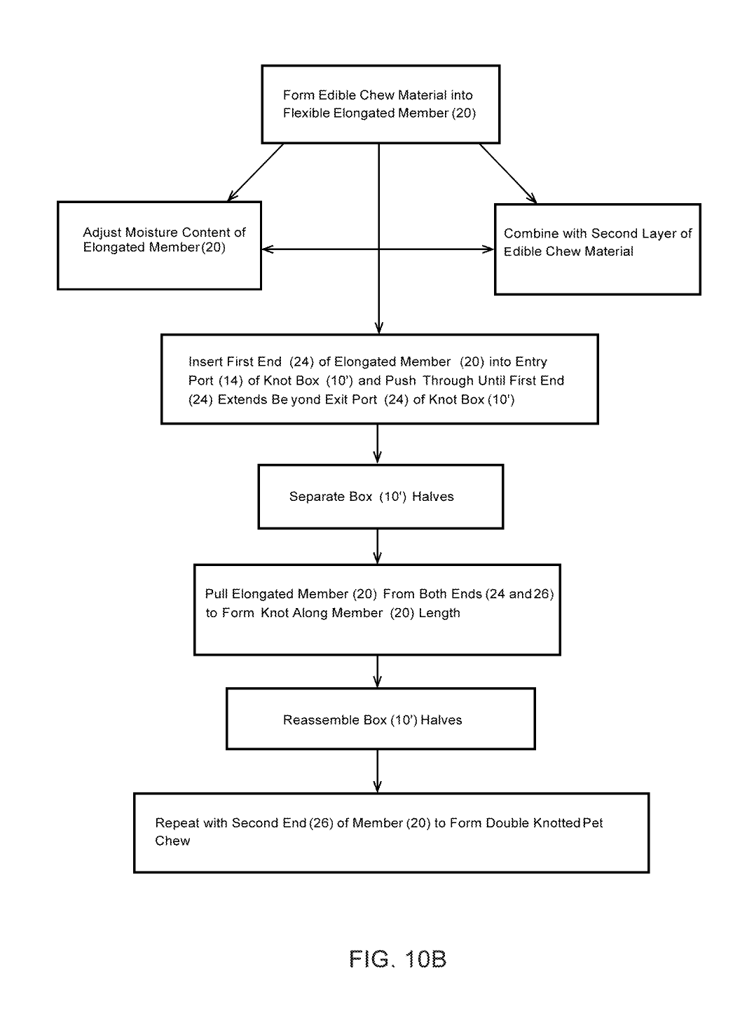

The steps of the method of the instant invention are further illustrated in FIG. 10A, employing the first embodiment knot box 10 and in FIG. 10B, employing the second embodiment knot box 10′.

According to the method illustrated in FIG. 10A, edible chew material is formed into flexible elongated members and, optionally, combined with a second layer of edible chew material. In a further optional step, the moisture content of the elongated member 20 is adjusted such that it is of sufficient stiffness to follow the outside surface of chamber 12 while retaining sufficient flexibility to be tied into knot 22.

In a subsequent step, first end 24 of elongated member 20 is inserted into entry port 14 of box 10 and pushed through box 10 until first end 24 of member 20 extends beyond exit port 16 of box 10.

First end 24 and second end 26 are then pulled, simultaneously, to form a knot along the length of member 20. Now knotted member 20 is withdrawn from the enlarged entry port 14.

The process is then repeated, in an optional final step, but with the insertion this time of second end 26 of elongated member 20 to mechanically form a double knot along the length of member 20.

The second embodiment method illustrated in FIG. 10B is similar in all respects to the first embodiment method illustrated in FIG. 10A except that, knot box halves 10′a and 10′b are separated following the insertion of elongated member 20 through box 10′, and prior to the knotting step. Also different is that box 10′ is reassembled following the first knot and prior to the optional step of repeating the method on the opposite end of member 20 to form a second knot.

### SUMMARY AND SCOPE

As will be appreciated from the description, examples and accompanying drawings, the novel method for making animal chews of the instant invention provides for a fully mechanized approach to making knotted animal chews, avoiding the expense and other negative aspects of employing human labor to complete mind-less, simple repetitive manual tasks.

This novel process for the fabrication of dog chews in which rolled or folded layered sheets are tied mechanically as opposed by human labor enables a U.S. domestic based manufacturing industry that can utilize domestic ingredients and quality assurance practices that reassures domestic consumers and create significant brand equity and margin premium.

Although the invention has been described in terms artificial dog bones comprised of layers of rawhide remnants, extruded plant material, meat and other protein, mechanically knotted into their final form, the method of the current invention can also be applied to artificial dog bones comprised of a rolled single layer, or two or more layers, and layers comprised of materials suitable for pet chews other than the materials specifically disclosed herein. Similarly, artificially knotted pet chews having knots other than the overhand knot described and illustrated, methods that results in an artificial pet bones having more than one type of knot, and potentially more than two knots, are considered to be fairly within the intent and scope of the disclosed invention.

Multiple variations and modifications are possible in the embodiments of the invention described here. Although certain illustrative embodiments of the invention have been shown and described here, a wide range of modifications, changes and substitutions is contemplated in the foregoing disclosure. While the above description contains many specifics, these should not be construed as limitations on the scope of the invention, but rather as exemplifications of one or another preferred embodiment thereof. In some instances, some features of the present invention may be employed without a corresponding use of the other features. Method steps may be followed in orders other than the orders described and illustrated herein. Accordingly, it is appropriate that the foregoing description be construed broadly and understood as being given by way of illustration and example only, the spirit and scope of the invention being limited only by the claims which ultimately issue.

1. A method for making knotted animal chews using a knot box comprising:
(a) forming edible chew material into a flexible elongated member;
(b) inserting a first end of said elongated member into the entry port of a knot box comprising a housing with tubular chamber, an entry port proximally, and an exit port distally, said chamber formed in the shape of the desired knot with a cutaway central section to accommodate knotting;
(c) inserting the first end of said elongated member into the entry port of said box and pushing said member the through the knot box chamber until said first end extends beyond the exit port;
(d) pulling said elongated member from both ends causing the member to form a knot along its length within said cutaway section of said chamber; and
(e) withdrawing said knotted member from said knot box entry port.

2. The method of claim 1, further comprising inserting the second end of the knotted elongated member into said entry port and repeating steps (c) through (e) but wherein the second end becomes the first end, to form an animal chew demonstrating a double knot.

3. The method of claim 1, wherein said edible chew material is selected from a group comprising treated rawhide remnants, extruded plant material, meat and other protein.

4. The method of claim 3, wherein different edible material are combined in layers.

5. The method of claim 1 wherein the cross-section shape of said elongated member is a selected from a group comprising a tube, a square, a flat sheet, and a flat sheet that has been folded upon itself along its longitudinal axis two or more times.

6. The method of claim 1 wherein the method is mechanized using mechanical arms and clamps to insert, push, pull and withdraw said elongated member from within said knot box.

7. The method of claim 1 wherein the entry port and exist port are interchangeable and the knotted member can be withdrawn from either the entry port or the exit port in step (e).

8. The method of claim 1 wherein the entry port is enlarged relative to the exit port to accommodate withdrawal of the knotted member in step (e).

9. The method of claim 1 further comprising adjusting the moisture content of the elongated member to obtain the necessary stiffness and flexibility prior to insertion of the elongated member into the entry port of the knot box.

10. The method of claim 1 wherein the step of forming edible chew material is accomplished in whole or in part by extrusion.

11. A method for making knotted animal chews using a knot box comprising:
(a) forming edible chew material into a flexible elongated member;
(b) inserting a first end of said elongated member into the entry port of a knot box comprising a housing with tubular chamber, an entry port proximally, and an exit port distally, said chamber formed in the shape of the desired knot, and said box being separable into two halves along the longitudinal axis of said tubular chamber;
(c) inserting a first end of said elongated member into the entry port of said box and pushing the elongated member through the knot box chamber until said first end extends beyond the exit port;
(d) separating the two halves of said box to leave the elongated member unrestrained by said box;
(e) pulling said elongated member from both ends causing the member to form a knot along its length.

12. The method of claim 11, further comprising:
reassembling the knot box;
inserted the second end of the knotted elongated member into said entry port; and
repeating steps (c) through (e) of claim 11, but wherein the second end becomes the first end, to form an animal chew demonstrating a double knot.

13. The method of claim 11, wherein said edible chew material is selected from a group comprising treated rawhide remnants, extruded plant material, meat and other protein.

14. The method of claim 11, wherein different edible material are combined in layers.

15. The method of claim 11 wherein the method is mechanized using mechanical arms and clamps to insert, push, and pull said elongated member and to hold, separate and reassemble said knot box.

16. The method of claim 11 wherein the cross-section shape of said elongated member is a selected from a group comprising a tube, a square, a flat sheet, and a flat sheet that has been folded upon itself along its longitudinal axis two or more times.

17. The method of claim 1 further comprising adjusting the moisture content of the elongated member to obtain the necessary stiffness and flexibility prior to insertion of the elongated member into the entry port of the knot box.

18. The method of claim 11 wherein the step of forming edible chew material is accomplished in whole or in part by extrusion.

19. Animal chews made from the method described in claim 1.

20. Animal chews made from the method described in claim 11.
